(19) United States
(12) Patent Application Publication
(10) Pub. No.: US 2005/0250395 A1
(43) Pub. Date: Nov. 10, 2005

(54) Water management system for propeller shaft seal

(75) Inventor: Nikolaos Saranditis, West Palm Beach, FL (US)

Correspondence Address: SACCO & ASSOCIATES, PA, P.O. BOX 30999, PALM BEACH GARDENS, FL, 33420-0999, US

(73) Assignee: Anchor Technology, LLC, West Palm Beach, FL (US)

(21) Appl. No.: 10/840,715

(22) Filed: May 6, 2004

(51) Int. Cl. B63H 23/34; B63H 23/36; F16J 15/38

(52) U.S. Cl. 440/83; 440/112

(57) ABSTRACT

Water management system for a propeller shaft stuffing box. The water management system includes a containment vessel sized and shaped to fit around a propeller shaft stuffing box. The containment vessel has first and second axially-aligned shaft bores at opposing ends thereof. The shaft bores are provided for receiving therein a propeller shaft.

### FIELD OF THE INVENTION

This invention is directed generally to marine propulsion systems, and more particularly to power train improvements for inboard engine boats.

### BACKGROUND

Boats with inboard engine installations are well known in the art. Typically, the engine is mounted in an engine box or below deck within the confines of the boat's hull. The engine is typically coupled to a propeller by a propeller shaft. The propeller shaft passes through the hull of the boat and rotates the propeller to propel the boat forward through the water.

The location where the propeller shaft passes through the hull is generally below the waterline on the boat. Accordingly, some means must be provided to form a watertight seal. The watertight seal is intended to prevent water from entering the boat, while also allowing the propeller shaft to rotate. In most inboard boats, a stuffing box is provided to form the watertight seal.

There are several known problems with stuffing boxes. One problem is that proper adjustment of stuffing boxes must be constantly maintained to ensure that they provide an adequate seal, while not leaking excessively. Stuffing boxes are ideally adjusted so that they form a watertight seal when the shaft is stopped, but allow a small amount of water to pass through the seal when the shaft is turning. This will usually result in water dripping from the seal. A properly adjusted stuffing box will usually leak at a rate of two or three drops of water per minute when the shaft is turning. This water is generally allowed to collect in the bilge, and is pumped overboard as needed.

One problem with stuffing boxes is their tendency to leak at a rate much higher than the recommended two or three drops per minute. Usually this is an indication that the packing material needs to be replaced, or the stuffing box is improperly adjusted. This higher rate of leakage can be a problem because the spinning shaft will disburse the excess water over the engine compartment. This can lead to excessive levels of corrosion occurring within the engine compartment. A far more serious problem with leaky stuffing boxes is the risk that they could cause the boat to sink.

The solution to a leaky stuffing box is relatively simple. The hollow nut must be tightened or the packing may need to be replaced. However, access to stuffing boxes can be difficult, particularly in boats with V-drives and in sailboats. Accordingly, boaters often fail to check the condition of the stuffing box with sufficient frequency to discover the excessive leakage. Excessive amounts of water collecting in the bilge can be an indication of an improperly adjusted packing box. However, water can and does enter the bilge from many other sources. Accordingly, the additional accumulation of water from a leaky packing box can easily be attributed to the normal operation of the boat. Further, bilge areas are often difficult to access, and unusually high rates of water accumulation in the bilge can often go undetected. Often this is because such accumulations of water are routinely pumped out by means of automatic bilge pumps.

### SUMMARY OF THE INVENTION

This invention relates to a method and apparatus for collection of excess water leaking from a stuffing box of an inboard engine boat propeller shaft. The method can include shielding an engine compartment from a discharge of water from the stuffing box, and collecting the discharge of water. According to one aspect of the invention, the engine compartment can be shielded from the discharge of water in all radial directions around the stuffing box. This ensures that the engine compartment is protected from a radial spray of water caused by rotation of the propeller shaft.

The method can also include the step of surrounding the stuffing box with a containment vessel for performing the shielding step and the collecting step. The containment vessel can be any suitable shape or size for being fitted around the stuffing box. For example, the containment vessel can be a cylindrical collar positioned coaxial about the propeller shaft. The method can also include the step of mounting the containment vessel to a stationary structure coaxial about the propeller shaft. For example the stationary structure can be a shaft log for the propeller shaft.

Regardless of the precise arrangement of the containment vessel, the method can continue by accumulating the discharge of water collected by the Containment vessel in a holding tank. The collection of water from the stuffing box in the holding tank can be advantageously arranged such that no other sources of water can enter the holding tank. Such an arrangement facilitates monitoring of water discharge as will be explained below.

The method can also include a monitoring step. In the monitoring step, the rate at which water enters the holding tank can be monitored. Such monitoring can be used to determine the rate of water leakage from the stuffing box. According to one aspect of the invention, the monitoring step can include automatically switching on a pump to remove accumulated water from the holding tank when it reaches a predetermined level. It can also include tracking or counting the number of times the pump is switched on within a predetermined period of time. An excessive rate of water accumulation can be indicated when the number of times the pump is turned on, within a predetermined period of time, exceeds a predetermined number. The monitoring process can continue by communicating a warning if the rate of water accumulation in the holding tank is determined to be excessive. This step can include illuminating a warning lamp, displaying a warning message, or sounding a warning alarm.

In another embodiment, the invention is a water management system for a propeller shaft stuffing box. The water management system can include a containment vessel that is sized and shaped to fit around a propeller shaft stuffing box. The containment vessel can have first and second axially-aligned shaft bores at opposing ends thereof. The shaft bores are provided for receiving therein a propeller shaft. Further, a support structure can be provided for supporting the containment vessel in axial alignment with the propeller shaft. According to one aspect of the invention, the support structure can include a sleeve disposed adjacent the first shaft bore. The sleeve can extend a predetermined distance toward the second shaft bore. Further, the sleeve can support the containment vessel on a shaft log in axial alignment with the propeller shaft. According to another aspect of the invention, the support structure can include at least one clamp for securing the containment vessel to a shaft log of the propeller shaft.

The water management system can also include a holding tank in fluid communication with the containment vessel. The holding tank can be used for accumulating water from the containment vessel. The system can also include a pump responsive to an automatic switch. The automatic switch can be responsive to a water level in the holding tank for automatically cycling the pump on and off to remove accumulated water from the holding tank.

According to yet another aspect of the invention, the system can include a control unit. The control unit can be used to monitor a rate of water accumulation in the holding tank. For example, the control unit can monitor the rate of water accumulation in the holding tank. The monitoring can be performed by evaluating the number of times the pump is cycled during a predetermined period of time. The control unit can also generate a warning signal when the rate of water accumulation exceeds a predetermined rate. A warning indicator device can be provided for this purpose to alert a user that a stuffing box is leaking excessively. The alert can be useful to warn a user that the stuffing box requires maintenance or repair.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is partial cross-sectional view of a boat hull showing an inboard motor propeller shaft and stuffing box of the prior art.

FIG. 2 is a cross-sectional view of a portion of the propeller shaft and stuffing box taken along line 2-2 in FIG. 1.

FIGS. 3A-3B are a series of perspective views showing how a water collar can be fitted around the stuffing box in FIG. 1.

FIG. 4 is a is partial cross-sectional view of the boat hull in FIG. 1 showing the water collar mounted around the stuffing box.

FIG. 5 is a cross-sectional view of the stuffing box taken along line 5-5 in FIG. 4.

FIG. 6 is a block diagram that is useful for understanding a water management system of the invention.

### DETAILED DESCRIPTION OF THE INVENTION

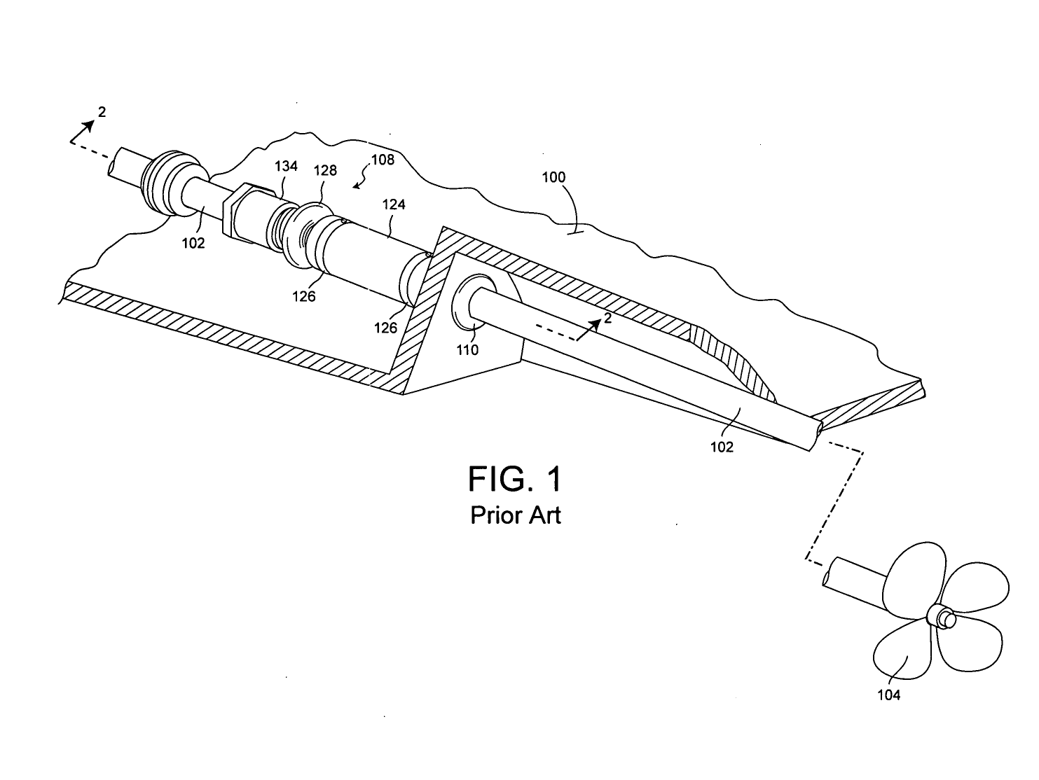

FIG. 1 is a partial cross-sectional view of a boat hull 100 showing a typical arrangement for a propeller drive system. A propeller shaft 102 is provided for coupling motive force from an inboard engine (not shown) to a propeller 104. Additional struts, (not shown) can support the propeller shaft on the exterior of the boat hull. Stuffing box 108 is provided to form a substantially watertight seal around the propeller shaft to prevent water from entering the interior of the boat hull. Stuffing boxes are well known in the art.

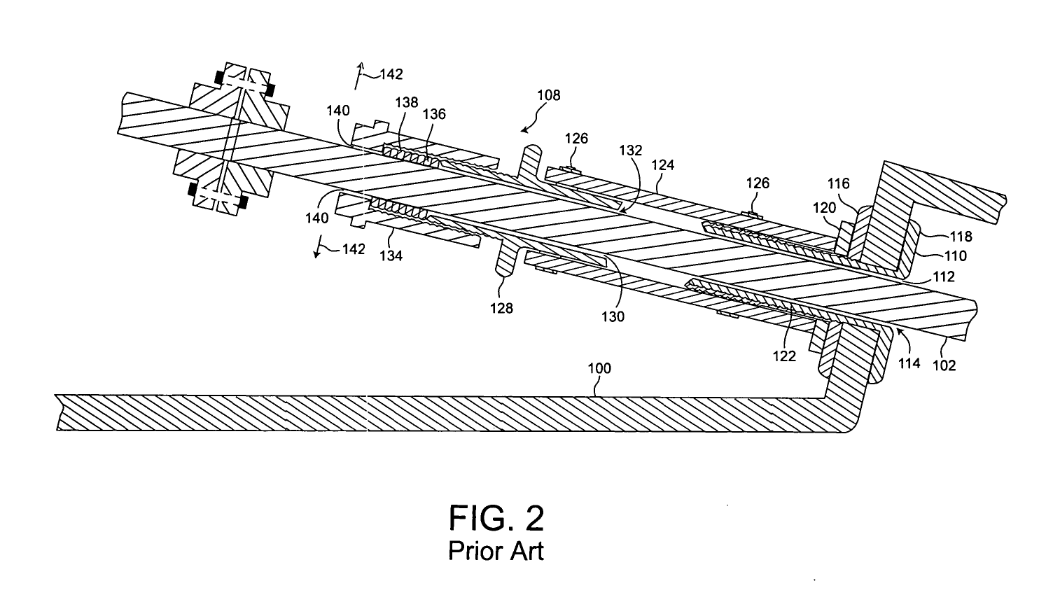

A cross-sectional view of the propeller shaft and its associated components is illustrated in FIG. 2. A shaft log 110 is provided where the propeller shaft 102 passes through the hull 100. The shaft log 110 is generally formed as a hollow cylindrical housing 122 with an outer flange 118. An inner flange 116 and a retaining nut 120 are threaded onto the hollow cylindrical housing. Tightening the inner flange 116 toward the outer flange 118 secures the shaft log to the hull. The diameter of an interior bore 112 of the shaft log 110 is typically formed slightly larger than the outside diameter of the propeller shaft 102. This creates a small ring-like opening 114 through which water can pass around the outside of the shaft.

A flexible hose 124 is typically fitted at one end around the hollow cylindrical housing 122 of the shaft log. At the other end, the flexible hose 124 is usually connected to a compression sleeve 128 which forms part of the stuffing box 108. The flexible hose 124 is generally secured to hollow cylindrical housing 122 and the compression sleeve 128 by means of a hose clamp 126 or other similar device. Like the shaft log, the compression sleeve 128 has an interior bore 130 that is formed slightly larger than the outside diameter of the propeller shaft 102. This creates a small ring-like opening 132 which is useful for allowing water to pass around the outside of the propeller shaft.

A hollow nut 134 is threaded on the compression sleeve as shown in FIG. 2. The propeller shaft passes axially through the center of the hollow nut and the compression sleeve 128. Packing material 136 is disposed in a packing chamber 138 within the hollow nut 134 and surrounding the propeller shaft 102. The packing material is typically formed from braided flax rope that has been impregnated with wax and lubricants. When the hollow nut 134 is screwed down on the threaded portion compression sleeve 128, it decreases the space available in the packing chamber, causing the packing to be compressed against the propeller shaft. The compression of the packing seal in this way forms a substantially watertight seal. Still, the propeller shaft is able to turn because it is surrounded by the packing material.

Water can enter the packing chamber 138 from outside the hull to help lubricate the propeller shaft. Water from outside the hull passes through ring-like opening 114. The water travels along the outside of the propeller shaft 102 within the flexible hose 124, until it passes through ring-like opening 132 and enters the packing chamber. Typically, a small amount of water will be allowed to pass through the stuffing box 108 and exit around the propeller shaft through ring-like opening 140. This leakage is normal for a stuffing box, particularly when the propeller shaft 102 is rotating. Still, an improperly adjusted or poorly maintained stuffing box will leak excessively. Moreover, when the propeller shaft 102 is rotating, this excess water will be spun off the propeller shaft. The water will be generally directed in a radial direction 142 around the entire circumference of the propeller shaft 102. This discharge of water is the result of centrifugal force associated with the spinning propeller shaft and can cause significant corrosive damage in an engine compartment.

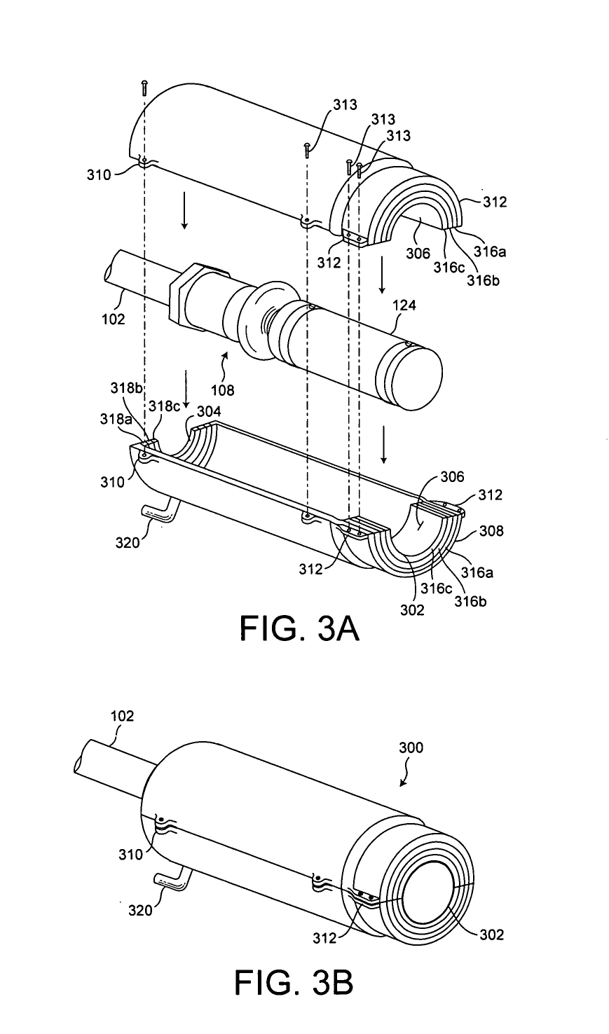

FIGS. 3A and 3B show that a containment vessel 300 can be fitted around the stuffing box 108 to shield an engine compartment from water thrown from ring-like opening 140. At least one drain port 320 can be provided to allow water to drain from the containment vessel 300. The exact size and shape of the containment vessel 300 is not critical. However, the containment vessel can be advantageously sized and shaped to fit compactly around a propeller shaft stuffing box. For example, the containment vessel 300 can be cylindrically shaped as shown in FIGS. 3A and 3B to fit closely around the shaft log 110, flexible hose 124, and stuffing box 108. Still, the invention is not limited in this regard and a variety of other shapes and sizes of containment vessels can also be used. All that is required is that the containment vessel shield the surrounding engine compartment from a spray of water from the stuffing box, and collect the water so it can be monitored or discharged from the compartment.

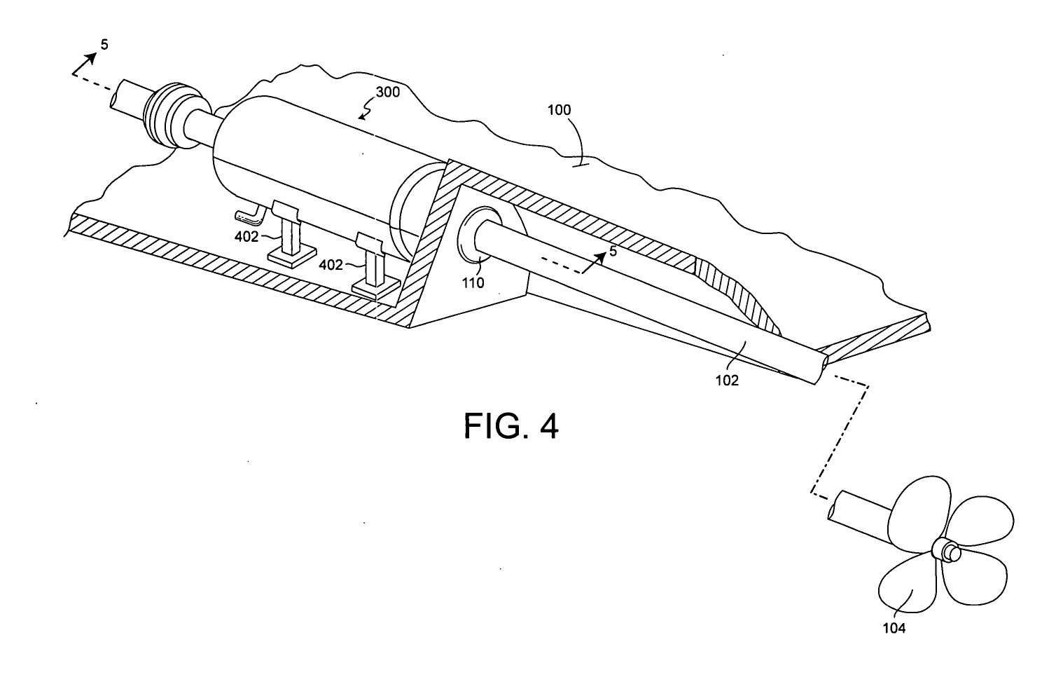

As illustrated in FIGS. 3A and 3B, the containment vessel 300 can have shaft bores 302, 304. The shaft bores 302. 304 can be axially-aligned at opposing ends of the containment vessel 300. Shaft bore 304 should be at least large enough to allow propeller shaft 102 to pass through. A slip ring or other type of bearing (not shown) can be disposed between the shaft bore 304 and the propeller shaft 102. However, a bearing is not necessary. Instead, the shaft bore 304 can have a diameter appropriately sized to fit closely around propeller shaft 102 without actually touching the propeller shaft at any point. In this way, the containment vessel 300 can prevent the escape of water sprayed from ring-like opening 140 while still ensuring that shaft 102 can rotate freely. In FIG. 4, the containment vessel 300 is shown installed on the propeller within the boat hull of FIG. 1.

As illustrated in FIG. 3, the containment vessel 300 can be formed from upper and lower casing 306, 308. The upper and lower casings 306, 308 can be formed from any material provided that it is capable of performing as described herein. However, the material can advantageously be selected to be a rigid plastic. For example, a marine grade polyvinylchloride material (PVC) can be used for this purpose. The upper and lower casings 306, 308 can be joined together by any suitable means. For example, threaded lugs 310, 312 can be secured to one another with suitable screws or bolts. Still, the invention is not limited in this regard and any other conventional attachment means can be used as would be known to one skilled in the art. A sealing gasket (not shown) can be provided to form an improved seal along an edge where the upper and lower casings 306, 308 are joined together. The sealing gasket can include a rubber o-ring, an interlocking edge structure or any other arrangement as would be known to one skilled in the art.

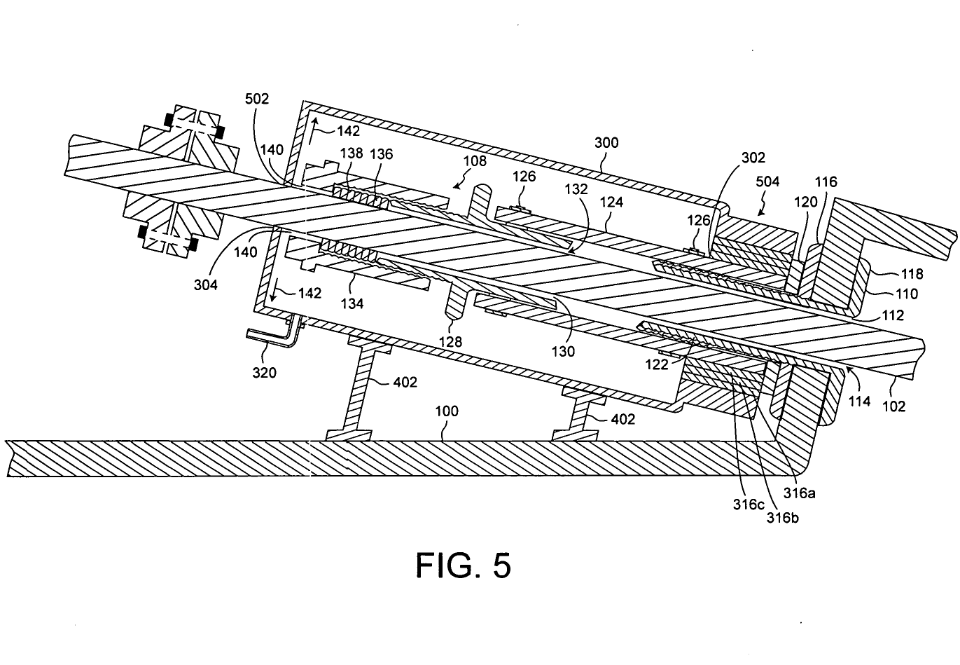

Referring now to FIG. 5, it can be observed that the containment vessel 300 can extend from just forward of the ring-like opening 140 to a location displaced somewhat toward the shaft log 110. It will be appreciated that the containment vessel 300 need not extend along the axis of the propeller shaft to the full same extent illustrated in FIG. 5. Instead, the containment vessel 300 need only extend a distance along the propeller shaft axis sufficient to ensure that substantially all of the spray emitted from the ring-like structure 140 is shielded from the engine compartment. However, according to an embodiment of the invention illustrated in FIG. 5, the containment vessel can extend from a first location 502, just forward of the ring-like opening 140, to a second location 504. The second location 504 can be selected so that the containment vessel extends at least partially over the shaft log 110 and flexible hose 124. In this way, the containment vessel 300 can be at least partially supported by the shaft log 110.

The containment vessel 300 can advantageously include a support structure for supporting the containment vessel in axial alignment with the propeller shaft. Any suitable bracket can be used for this purpose. For example the containment vessel can be supported by brackets 402 as illustrated in FIGS. 4 and 5. Alternatively, the containment vessel 300 can be at least partially supported on the shaft log 110 and flexible hose 124.

If the containment vessel is to be supported on the shaft log 110, then a sleeve 306 can be provided. According to one embodiment, sleeve 306 can be formed as a thickened wall portion of the containment structure as shown. Screws 313 and threaded lugs 312 can be used to secure the upper and lower half of sleeve 306 together around the flexible hose 124 and/or hollow cylindrical housing 122. In this way, the sleeve 306 can be clamped around an outer portion of flexible hose 124 in an area where the flexible hose is lapped over the hollow cylindrical housing 122. Alternatively, the sleeve 306 can be clamped directly around a portion of the shaft log not overlapped by the flexible hose.

Mounting the containment structure on the flexible hose 124 where the flexible hose overlaps the shaft log 110 can be advantageous. For example, the interface between the sleeve 306 and the flexible hose 124 can form a substantially watertight seal that can further help contain any water collected in the containment device 300.

Referring now to FIGS. 3A and 5, it can be seen that the sleeve 306 can have a relatively broad face extending a predetermined distance between shaft bore 302 and shaft bore 304. The precise distance will depend upon a variety of factors. In general however, the width of the face should be selected so that it can support the remainder of the containment vessel 300 in axial alignment with the propeller shaft when mounted to the flexible hose 124 and/or the cylindrical housing 122. Still, those skilled in the art will readily appreciate that other mounting methods are also possible and the invention is not intended to be limited to the precise mounting arrangements disclosed herein.

From the foregoing discussion, it will be appreciated that the diameter of the opening provided by shaft bores 302, 304 can be an important consideration in any practical installation of the containment vessel 300. However, a variety of propeller shaft diameters, shaft log diameters, and flexible hose diameters can be found in different boats. Accordingly, in order to alleviate stock and manufacturing requirements for the containment vessel 300, each of the shaft bores 302, 304 can be formed as a series of concentric rings. For example, shaft bore 302 can be formed using a stack of concentric ring pieces 316a, 316b, and 316c. Inner rings of the stack can be removed to accommodate shaft logs 110 and flexible hoses 124 having relatively large diameters. Similarly, propeller shafts of different size diameters can be accommodated by selectively removing one or more of concentric ring pieces 318a, 318b, and 318c. If necessary, the ring pieces 318a, 318b, 318c can be formed of a single piece that is scored or perforated along a radial edge so that the ring pieces can be easily snapped apart.

Drain port 320 can be located anywhere on the containment vessel 300, provided that it facilitates at least some drainage of water from the containment vessel. However, because of the angled orientation of the propeller shaft 102, it can be advantageous in some instances to locate the drain port 320 closer to the shaft bore 302 as compared to shaft bore 304. This can ensure that water collected in the containment vessel 300 is more efficiently drained from the containment vessel. Still, space constraints in the area between the containment structure 300 and the hull 100 can require the drain port 320 to be located closer to the shaft bore 304.

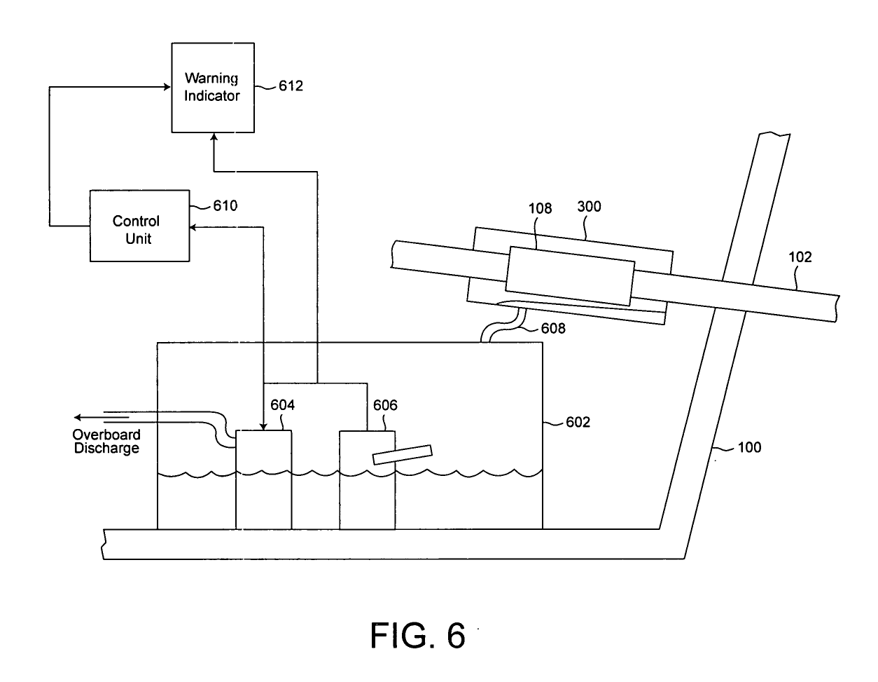

Water collected by the containment vessel 300 can be allowed to drain from drain port 320 directly into a boat bilge. The water can be pumped out using a conventional bilge pump and float arrangement. Alternatively the water management system described herein can also include a holding tank 602 as illustrated in FIG. 6. The holding tank 602 can be provided for accumulating water exclusively from the stuffing box 108. The holding tank 602 can be in fluid communication with the containment vessel 300. For example a conduit 608 can direct water collected in the containment vessel 300 to the holding tank 602. The conduit 608 can be connected at one end to the drain port 320 and can be connected at an opposing end to the holding tank.

A pump 604 can be provided for pumping water out of the holding tank 602. The pump 604 can be any type of fluid pump. For example, a conventional electric bilge pump can be used for this purpose. The pump 604 can be wired to an automatic switch 606. The automatic switch 606 can be any type of switch that is responsive to a change in water level in the holding tank 602. For example, the automatic switch can be a conventional bilge pump float switch. The automatic switch 606 can be wired to automatically cycle the pump 604 on and off to remove accumulated water from the holding tank 602. According to one embodiment, a warning indicator 612 can be wired to the automatic switch 606 to produce a warning notification when the pump 604 has been turned on to evacuate the holding tank. The warning indicator can be any suitable device for alerting a user to the activation of the pump 604. For example, the warning indicator 612 can be a lamp, a horn, or warning information displayed on any type of user interface screen. In this way, the rate of water collection in the holding tank can be monitored. Frequent and repeated activation of the warning indicator can indicate a problem with the stuffing box.

Instead of, or in addition to the foregoing, the system described herein can include a control unit 610. The control unit can be used to monitor a rate of water accumulation in the holding tank. For example, the control unit 610 can monitor the rate of water accumulation in the holding tank based on the number of times the pump 604 is cycled on and off during a predetermined period of time. The control unit can also generate a warning signal when the rate of water accumulation exceeds a predetermined rate. For example, if the pump 604 is cycled more than a predetermined number of times during a predetermined period of time, then a warning signal can be generated. The number of pump cycles and the time period can be fixed or can be selected by a user. In any case, the warning signal can activate the warning indicator 612 to alert a user that a stuffing box is leaking excessively. The alert can be useful to warn a user that the stuffing box requires maintenance or repair.

The control unit 610 described herein can be implemented as a microprocessor programmed with a set of instructions. Alternatively, the control unit can be implemented primarily in software as an application program that is read into and executed by a general-purpose computer. The general-purpose computer can include peripheral hardware such as one or more central processing units (CPUs), a random access memory, and input/output (I/O) interface(s).

The general-purpose computer can also include an operating system and microinstruction code. The various processes and functions described herein relating may be either part of the microinstruction code or application programs which are executed via the operating system. In addition, various other peripheral devices may be connected to the computer.

The invention described and claimed herein is not to be limited in scope by the preferred embodiments herein disclosed, since these embodiments are intended as illustrations of several aspects of the invention. Any equivalent embodiments are intended to be within the scope of this invention. Indeed various modifications of the invention in addition to those shown and described herein will become apparent to those skilled in the art from the foregoing description. Such modifications are also intended to fall within the scope of the appended claims.

1. A method for monitoring water leaking from a stuffing box of an inboard engine boat propeller shaft, comprising the steps of:
shielding an engine compartment from a discharge of water from said stuffing box;
collecting said discharge of water in a holding tank exclusively provided for said discharge of water from said stuffing box:
monitoring a rate of water collection in said holding tank; and
communicating a warning if said rate of water collection exceeds a preset value.

2. The method according to claim 1, wherein said shielding step is further comprised of blocking said discharge of water in all radial directions around said stuffing box.

3. The method according to claim 1, further comprising the step of surrounding said stuffing box with a containment vessel for performing said shielding step and said collecting step.

4. The method according to claim 3, further comprising the step of selecting said containment vessel to be a cylindrical collar positioned coaxial about said propeller shaft.

5. The method according to claim 3, further comprising the step of mounting said containment vessel to a stationary structure coaxial about said propeller shaft.

6.-7. (canceled)

8. The method according to claim 1, further comprising the step of pumping said water out of said holding tank.

9. (canceled)

10. The method according to claim 8, wherein said monitoring step further comprises:
automatically operating a pump to remove said water from said holding tank when it reaches a predetermined level; and
counting the number of times said pump is operated within a predetermined period of time

11. The method according to claim 10, further comprising the step of communicating a warning if said number of times said pump is operated within a predetermined period of times exceeds a predetermined number.

12. The method according to claim 11, wherein said communicating step comprises at least one of illuminating a warning lamp, displaying a warning message, and sounding a warning alarm.

13. A water management system for a boat propeller shaft stuffing box, comprising:
a containment vessel disposed around a stuffing box, said containment vessel shielding an engine compartment of said boat from a discharge of water from said stuffing box, and collecting said discharge of water,
a holding tank in fluid communication with said containment vessel and exclusively receiving water collected by said containment vessel;
a pump connected to said holding tank and a float switch connected to said pump for automatically turning said pump on and off, said pump removing at least a portion of said water from said holding tank: when said water reaches a predetermined level;
an electronic circuit for monitoring the rate of water collection in said holding tank, said electronic circuit comprising a counting circuit for determining the number of times said pump is operated during a predetermined period of time; and
an alerting device for communicating a warning indication when said pump is operated a certain number of times within a predetermined period of time.

14. The water management system according to claim 13, wherein said containment vessel is sized and shaped to contain said discharge of water in all radial directions around said stuffing box.

15. The water management system according to claim 13, wherein said containment vessel has at least a first shaft bore fitted around a first portion of the propeller shaft, and at least a second shaft bore fitted around a second portion of said propeller shaft, said first and second shaft bores axially-aligned.

16. The water management system according to claim 15, wherein said containment vessel defines a cylindrical collar positioned coaxial about said propeller shaft.

17. The water management system according to claim 15, wherein said containment vessel is mounted to a mounting structure coaxial about said propeller shaft that remains stationary when said propeller shaft is rotating.

18. The water management system according to claim 17, wherein said mounting structure comprises a shaft log.

19-24. (canceled)

25. The water management system according to claim 13, wherein said alerting device is selected from the group consisting of a warning lamp, a text message on a display device, and a warning alarm.

26. A water management system for a propeller shaft stuffing box, comprising:
a containment vessel, sized and shaped to fit around a propeller shaft stuffing box, said containment vessel having first and second axially-aligned shaft bores at opposing ends thereof;
a support structure supporting said containment vessel in axial alignment with said propeller shaft;
a holding tank in fluid communication with said containment vessel for accumulating water from said containment vessel;
a pump responsive to an automatic switch, said automatic switch responsive to a water level in said holding tank for automatically operating said pump;
a control unit, said control unit monitoring a rate of water accumulation in said holding tank and generating a warning signal when said rate of water accumulation exceeds a predetermined rate;
wherein said control unit monitors said rate of water accumulation in said holding tank based on the number of times said pump is operated during a predetermined period of time.

27.-30. (canceled)

31. The water management system according to claim 26, further comprising a warning indicator device, said warning indicator device responsive to said control signal for alerting a user that said rate of water accumulation exceeds said predetermined rate, whereby an excessively leaking stuffing box can be detected.

32.-33. (canceled)

34. The water management system according to claim 26 wherein said support structure is comprised of at least one bracket configured for securing said containment vessel to a boat in a stationary position.

35. The water management system according to claim 26 wherein said support structure comprises at least one clamp for securing said containment vessel to a shaft log of said propeller shaft.

36. The water management system according to claim 26 wherein said containment vessel is further comprised of a sleeve disposed adjacent said first shaft bore, and extending a predetermined distance toward said second shaft bore for supports, said containment vessel on a shaft log in axial alignment with said propeller shaft.
